(19) United States
(12) Patent Application Publication
(10) Pub. No.: US 2006/0207371 A1
(43) Pub. Date: Sep. 21, 2006

(54) Gearing actuator

(76) Inventors: Frank Miehle, Friedrichshafen (DE); Jurgen Neuenfeld, Friedrichshafen (DE)

Correspondence Address: DAVIS & BUJOLD, P.L.L.C., 112 PLEASANT STREET, CONCORD, NH, 03301, US

(21) Appl. No.: 10/568,858

(22) PCT Filed: Jul. 27, 2004
(86) PCT No.: PCT/EP04/08371

§ 371 Date: Feb. 21, 2006

(30) Foreign Application Priority Data
Aug. 21, 2003 (DE) 103383751

(51) Int. Cl. F16H 61/28

(52) U.S. Cl. 74/473.1

(57) ABSTRACT

A gearing actuator, particularly an electromechanical gearing actuator for an automated transmission of a motor vehicle, having at least one driving device for the transmission and a shifting motion in the transmission and one assembly for converting the rotational motion of a driving device to a translational motion of the assembly, which has one spindle and one sliding part movable on the spindle. The spindle (2) is provided with at least one continuation (1) extending in axial direction and mounted for absorbing transverse forces in needle sleeves or ball sleeves (3).

This application is a national stage completion of PCT/EP2004/008371 filed Jul. 27, 2004 which claims priority from German Application Serial No. 103 38 375.1 filed Aug. 21, 2003.

### FIELD OF THE INVENTION

The invention concerns a gearing actuator for the preferably automated transmission of a motor vehicle.

### BACKGROUND OF THE INVENTION

Vehicles with automated transmissions find an increasingly extended use. In the first place, to them belong commercially used vehicles, such as vans and trucks; those automated transmissions are also increasingly used in sport designed, passenger or small cars. The object is to relieve the driver of the continuously required gear changes making a comfortable and, at the same time, reliable operation of the vehicle possible.

To this end, the driver usually has a selector switch available for selection of a mode of operation so that he can choose among an automatic mode, a manual shifting mode and a mode for a reverse gear. When the automatic mode is selected, an automatic ratio adaptation results. Mainly in the transmissions designed for trucks, there are several possibilities for automation of the transmission. Pneumatic, hydraulic or electric systems can thus be used. In the first place, the selection depends on the vehicle class and on the kinds of energy required in the vehicles. The power need of the actuators used also constitutes an important parameter. As actuators dependent on the system, pneumatic cylinders, hydraulic cylinders or electric motors are used which, via control elements, act upon the selection and shifting devices. The control elements, actuatable by an electric motor, at present are the construction of most favorable cost.

For a long time, it has been required for the manually shiftable transmissions of vehicles that they be supplemented with an electromechanical gearing actuator capable of automation. Electromechanical gearing actuators for gear change operations in a vehicle transmission have, in turn, been known for a long time. These are mostly used in a transmission which either has been developed together with the gearing actuator or has adaptation elements to be attached or installed in the existing transmission and can operate together with the gearing actuator.

One typical gearing actuator has been described, for example in EP 0 377 848 B1. This electromechanical gearing actuator has two axes of motion disposed perpendicular to each other. One single selector finger is guided by two electric motors to the axes of motion. The selector finger moved by the first electric motor here engages on the axis of motion corresponding to a selection motion in a respective opening in the different selector rods disposed in parallel side by side of each other. To shift a shifting set connected with a respective selector rod, by moving the selector finger to the second axis of motion, the shifting rod is moved by the second electric motor in direction of the longitudinal axis thereof. Even though the motion mechanism of the selector finger for movement, along the two axes of movement disposed perpendicular to each other, does correspond to the preset selection and shifting of the manual shifting pattern and also to the selection and motion of the respective shifting rod, this requires considerable installation space. The gearing actuator also needs a great number of parts.

To overcome the disadvantages, in the Applicant's DE-A-101 43 325, an electromechanical gearing actuator has been proposed and is to be fully included in this application, which comprises a first electric motor for executing a selection motion of a shifting device in the transmission of a motor vehicle and a second electric motor for executing a shifting motion of the shifting device. The control device belonging thereto can be wholly or partly integrated in the gearing actuator or can be designed as an external control unit. The axis of rotation of the first electric motor and the axis of rotation of the second electric motor are disposed parallel with each other.

To convert the rotation motion of the electromotors to a linear motion, ball circulation spindles driven, via a conversion of the appertaining motor, are used here and can be designed as bevel gear drive, spur gear drive, worm drive, etc. Instead of a ball circulating spindle with ball and nut movable thereon, it is possible to also use a thread, a spindle or a threaded spindle with screwed nuts corresponding thereto.

The ball circulating spindle for the shifting motion, described in connection with a preferred embodiment, is located in a shifting cylinder between two spring devices which operate in the direction of motion of the ball circulating spindle. If the ball circulating spindle for the shifting motion rotates around its axis, the ball nut disposed thereon is moved in axial direction thereby acting upon the spring device. The spring device is used as a force accumulator and prevents an overload of the transmission gearshift or of the driving unit with the electric motor, at the same time, taking care of a quick cutting through of the sliding sleeve after reaching the synchronization point.

To support the torque introduced in the ball circulating spindle, a crew or a pin is used, which is axially movable within the shifting cylinder, but prevents a torsion of the ball nut relative to the shifting cylinder. The ball nut, the spring device and the torque support are lodged in the shifting cylinder.

To connect the shifting cylinder with a relay lever and a selector finger, the axial motion of the shifting cylinder can be converted, via a cylindrical pin or a ball cylinder pair, to a motion of the shifting device extending perpendicular to the motion of the shifting cylinder along the ball circulating spindle. A torsion of shifting shaft and selector finger, relative each other, can be prevented by a force or form locking connection.

If the ball circulating spindle for selection motion is shifted via the appertaining electric motor to a rotational motion, the ball nut moves in axial direction on the ball circulating spindle. The selector finger connected with the ball nut is secured against torsion. Selector finger and ball nut can be designed in one piece here. The torque support can result by an axial guide of the selector finger in the housing of the gearing actuator.

In a preferred embodiment, a cross clutch is provided between the shaft of the electric motor and the ball circulating spindle. By way of the cross clutch or also any other force or form locking clutch, such as a multi-cornered or polygonal section clutch, an axial offset between rotational shaft of the electric motor and ball circulating spindle is to be compensated. The axial forces appearing in the ball circulating spindle are absorbed by a bearing of the ball circulating spindle in the housing of the gearing actuator and not transmitted to the rotational shaft of the electric motor.

However, the conventional ball circulating spindles, the same as the other conventional motion threads for gearing actuators, for converting the rotational motion to a translational motion are still affected with the disadvantage that even though they are able to reliably absorb axial forces during a long period of time, radial or transverse forces can only be absorbed to a certain extent. For the transverse forces to be better absorbable thus increasing the duration of the gearing actuator, linear guides have already been used, such as dovetail guides, round guides, flat guides, prismatic guides and combinations thereof. But in most cases, this kind of guide has a considerable negative effect on the degree of efficiency. They are usually disposed parallel with the axis of the motion thread thereby demanding considerable space both in width and in height.

The problem to be solved by this invention is to provide a gearing actuator in which a support of the transverse forces appearing on the spindle axis is ensured without requiring additional space in width.

### SUMMARY OF THE INVENTION

According to the invention, it is provided that a single support or multiple support of the transverse forces results on one cylinder in linear continuation of the longitudinal axis of the spindle and this while using roller or low-friction bearings. This kind of support exclusively requires the already existing installation space of the gearing actuator in longitudinal and not in transverse direction. A torsional safety is additionally provided here.

The single or multiple support of the spindle can result, for example, by one needle sleeve or also by one ball sleeve or several ball sleeves, which surround a section of the cylindrical continuation of the threaded spindle. One or more low-friction bearings can also be used instead of needle sleeves or ball sleeves or of needle bearings or ball bearings.

### BRIEF DESCRIPTION OF THE DRAWING

The invention will now be described, by way of example, with reference to the accompanying drawing in which:

FIG. 1 diagrammatically shows one section through the inventively developed gearing actuator in single version, and

FIG. 2 diagrammatically shows one section through the inventively developed gearing actuator in double version.

### DETAILED DESCRIPTION OF THE INVENTION

The construction of a gearing actuator is well known to the expert and has been described, in detail, in the introduction to the description so that only the parts needed for understanding the invention have been provided with reference numerals.

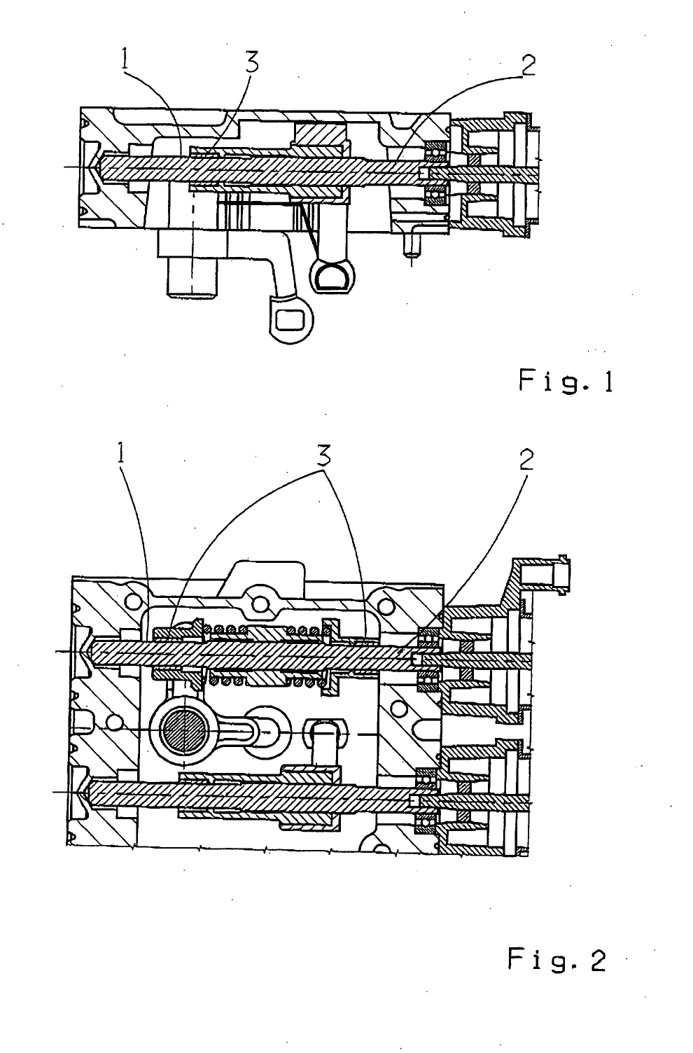

FIG. 1 diagrammatically shows one section through a gearing actuator which comprises one conversion device for converting a rotational motion to a translational motion, a spindle of which is designated with 2. The spindle has one cylindrical continuation 1 mounted for absorbing the transverse forces in the gearing actuator via one needle sleeve or ball sleeve 3.

In the embodiment, shown in FIG. 1, the gearing actuator is a single version, that is, it has only one spindle and only one movable part coacting therewith. Only one electric motor (not shown) for driving the spindle 2 is also provided. The transverse forces are supported here via a single support having only one needle sleeve or ball sleeve 3. Instead of needle sleeves or ball sleeves, needle bearings or ball bearings can also be provided or, if needed, low-friction bearings.

FIG. 2 diagrammatically shows one section through a gearing actuator, the spindle of which is, likewise, designated with 2. The spindle also has one cylindrical continuation or extension 1 mounted for absorbing the transverse forces in the gearing actuator via one needle sleeve or one ball sleeve 3.

In the embodiment shown in FIG. 2 with multiple support, one continuation 1 is provided on both sides of the spindle, each continuation being mounted in a needle sleeve or ball sleeve 3. Here the gearing actuator has a double function, that is, it has two spindles disposed parallel with each other which are driven by two electric motors (not shown) for selection and shifting, such as more specifically described in the Applicant's DE-A-101 43 325 cited above. Each spindle is identically provided with continuations mounted in the needle sleeves or ball sleeves for absorbing the transverse forces, but only the spindle 1 at bottom in the drawing with its continuations and sleeves has been provided with reference numerals.

Instead of the needle sleeves or ball sleeves, it is also possible here to use needle bearings or ball bearings and, if needed, also low-friction bearings.

It is clear that by virtue of the inventive construction of the gearing actuator, as already mentioned above, no additional installation space is required in radial direction for the single or multiple support of the continuations by way of needle sleeves and/or ball sleeves, but only in axial direction. Torsional safety is in addition provided.

### REFERENCE NUMERALS

1 continuation
2 spindle
3 bearing sleeve

1-4. (canceled)

5. An electromechanical gearing actuator for an automated transmission of a motor vehicle, the gearing actuator comprising at least one driving device for one or more of a shifting device and a shifting motion in the transmission and one assembly for converting rotational motion of the driving device to a translational motion of the assembly, which has one spindle and one sliding part that moves on the spindle, the spindle (2) is provided with at least one continuation (1) extending in an axial direction which has at least one bearing (3) for absorbing transverse forces with which the transverse forces can be supported on the spindle (2).

6. The gearing actuator according to claim 5, wherein the at least one bearing (3) is at least one needle sleeve.

7. The gearing actuator according to claim 5, wherein the at least one bearing (3) is at least one ball sleeve.

8. The gearing actuator according to claim 5, wherein the at least one bearing (3) is at least one low-friction bearing.
